(19) United States
(12) Patent Application Publication
(10) Pub. No.: US 2004/0017192 A1
(43) Pub. Date: Jan. 29, 2004

(54) 3-axis magnetic angular orientation sensor

(75) Inventors: Mark Clymer, Mystic, CT (US); Edward April, Mystic, CT (US)

Correspondence Address: Daniel G. Mackas, McCormick, Paulding & Huber LLP, CityPlace II, 185 Asylum Street, Hartford, CT, 06103, US

(73) Assignee: Clymer Technologies, LLC, Mystic, CT

(21) Appl. No.: 10/413,951

(22) Filed: Apr. 15, 2003

Related U.S. Application Data
(60) Provisional application No. 60/372,485, filed on Apr. 15, 2002.

(51) Int. Cl. G01B 7/30; G01B 7/14

(52) U.S. Cl. 324/247; 324/207.25; 324/207.21

(57) ABSTRACT

An orientation sensor includes a sensor body. At least four magnetic sensors are coupled to the sensor body. The sensors are positioned in a non-planar arrangement, one relative to the other. A processor is in communication with the magnetic sensors. The processor is programmed to compute, based on signals generated by at least three of the sensors, the magnitude of a vector oriented in a direction substantially coincident with an inclination direction of a magnetic field in which the sensor is located.

### CROSS-REFERENCE TO RELATED APPLICATIONS

This application claims priority based on Provisional Patent Application No. 60/372,485 filed on Apr. 15, 2002 entitled “A 3-Axis Magnetic Angular Orientation and Rate Sensor,” the entire disclosure thereof being incorporated herein by reference.

### FIELD OF THE INVENTION

The present invention relates generally to angular orientation sensors and is more specifically related to an orientation sensor that employs a magnetic field as a reference.

### BACKGROUND OF THE INVENTION

The ability to determine changes in the angular orientation of a body in three-dimensional space can provide valuable data. For example, by knowing how the orientation of an artillery shell changes after it has been fired, the spin rate of the shell can be tracked and the shell appropriately armed. Understanding angular movement of a body, for example, a movement of the bow relative to the stern on a ship yields a better understanding of the hull stresses which in turn allows designs to be optimized.

One method of measuring changes in the angular orientation of a body involves detecting the earth's magnetic field using three-axis magnetometers. The magnetic field generated by the earth is employed as a reference.

Generally, three-axis magnetometers include three magnetic sensors oriented orthogonally relative to each other. These magnetometers rely on resolving the magnitude of the magnetic field detected by each magnetic sensor to determine three orthogonal components of the earth's magnetic field at the location of the magnetometer. By knowing the orthogonal components of the earth's magnetic field at the location of the magnetic sensor, the global position of the magnetometer can be determined. Thus, by monitoring changes in magnetic field detected by the sensors, the changes in the angular orientation of the magnetometer, or a body to which it is attached, can be determined. A problem with this type of magnetometer is that it relies on coordinating determined orthogonal components with existing orthogonal component data. Thus to use these magnetometers, precise knowledge of the magnetic field where the magnetometer is being used is required.

Another difficulty associated with the above-described magnetometer is that the sensitivity and offset of each magnetic sensor within the magnetometer is critical to the operation of the magnetometer. In order to determine the orthogonal components at the location of the magnetometer, each magnetic sensor must have a precise signal, generally electrical, relationship with the other magnetic sensors. Thus, each magnetic sensor must maintain zero and offset values as well as have low drift characteristics, preferably zero, with temperature change. As a result, the manufacturing tolerances for these magnetometers make these magnetometers expensive.

A commonly employed magnetic sensor in magnetometers is of the magnetoresistive type. These magnetic sensors have the problem that when attempting to detect the earth's magnetic field, which is very weak, the magnetic sensor generates a very weak signal that must be highly amplified to be useful. Since the earth's magnetic field is weak, these magnetic sensors are susceptible to offset shift and even polarity flipping when exposed to stray magnetic fields. To overcome this problem, magnetometers employing these magnetic sensors commonly incorporate flipping coils and current straps, which leads to the problems of increased power consumption and processing complexity. The increased power consumption and processing complexity increases the overall size of the magnetometers making it difficult to effectively employ the magnetometer in dynamic environments, such as those found in artillery or missile applications. Also these ancillary systems increase cost of both components and manufacturing. Other types of magnetic sensors, such as fluxgate, have similar problems.

Based on the foregoing it is an object of the present invention to overcome or improve upon the problems and drawbacks of the prior art.

### SUMMARY OF THE INVENTION

The invention resides in one aspect in a 3-axis magnetic angular orientation sensor for determining changes in angular orientation of a body to which it may be attached. The orientation sensor includes at least four magnetic sensors coupled to a sensor body and positioned in a non-planar arrangement relative to one another. Each of the sensors detects the magnitude and direction, proximate the sensor, of a magnetic field in which the orientation sensor is positioned.

A processor in communication with each of the magnetic sensors is programmed to resolve at least three of the signals generated simultaneously by the sensors into a vector. The vector has a direction consistent with the inclination of the magnetic field (discussed below) within which the orientation sensor is located. By re-computing the magnitude and direction of the vector indicative of the inclination of the magnetic field at different times, differences in the direction of the vectors can be equated to changes in angular position of the orientation sensor that has a plurality of magnetic sensors associated with it.

The sensors are arranged in a non-planar array relative to one another. The orientation sensor is positioned in a magnetic field wherein each of the individual sensors detects the magnitude and direction of the magnetic field proximate to it. A processor forming part of the orientation sensor and in communication with each of the magnetic sensors determines, based on signals received from each of the magnetic sensors at a first time, the magnitude of a first vector oriented approximately coincident with an inclination angle defined by the magnetic field. The magnitude of a second vector oriented approximately coincident with an inclination angle defined by the magnetic field is determined at a second time. The direction of the first and second vectors are compared to determine a change in angular position of the orientation sensor.

### BRIEF DESCRIPTION OF THE DRAWINGS

FIG. 1 shows a cross-sectional side view of a 3-axis magnetic sensor.

FIG. 2 shows an expanded view along line 2-2 of FIG. 1.

FIG. 3 shows a cross-sectional side view of a second embodiment of a 3-axis magnetic sensor.

FIG. 4 shows an expanded perspective view of the magnetic sensor array depicted in FIG. 3 in the circle identified with the number 4.

### DETAILED DESCRIPTION AND PREFERRED EMBODIMENTS

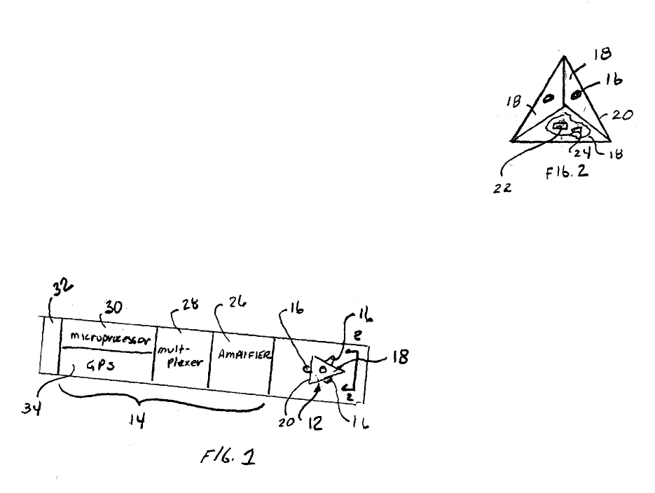

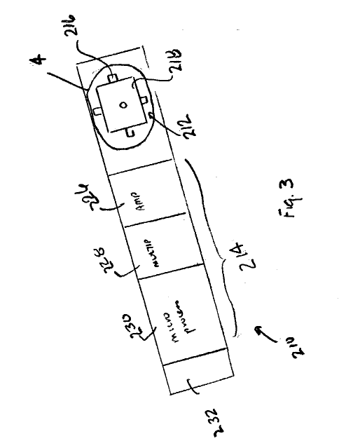

Referring to FIGS. 1 and 2, a 3-axis magnetic sensor, generally denoted by the reference number 10, includes a magnetic sensor array 12 that communicates, preferably electrically with a processing unit 14.

The magnetic sensor array 12 has four magnetic sensors 16, such as bipolar magnetoresistive sensors, coupled to faces 18 defined by a sensor body 20. The sensor body 20 fixes the spatial relationship of the magnetic sensors 16 relative to one another. The sensor body 20 is arranged to position the magnetic sensors 16 in the magnetic sensor array 12 in a non-planar arrangement. While the sensor body 20 is shown as being pyramid shaped, the invention should not be considered so limited as any one of a number of different shapes can be employed.

In the illustrated embodiment, the magnetic sensors 16 are electrically connected to a resistive bridge 22. A magnet 24, such as a rare earth magnet, is positioned proximate the magnetic sensor 16 and provides a hard bias therefor. By positioning a magnet 24 next to the magnetic sensors 16, any offset exhibited by the sensors of the magnetic sensor is fixed thereby eliminating polarity flipping. The magnet 24 should be appropriately sized, have a magnetic strength, such as to maintain the sensitivity of the magnetic sensors 16 to the magnetic field being measured.

The resistive bridge 22 is electrically connected to the processing unit 14. The processing unit 14 includes an amplifier 26, a multiplexer 28, and a microprocessor 30. The magnetic sensors 16 are multiplexed through a single amplifier circuit with the signals generated therefrom being fed into the microprocessor 30. As discussed below, the microprocessor 30 is programmed with appropriate software, such as neural net logic, to evaluate and analyze the signals from the various magnetic sensors 16. The processing unit 14 is powered by a power supply 32.

In operation, each magnetic sensor 16 continuously generates signals indicative of the strength of the magnetic field detected based on the individual orientation of the magnetic sensor in the magnetic field. All magnetic sensor signals cooperate together and based on the spatial relationship between the magnetic sensors 16, the signals when analyzed collectively can be used to determine the magnitude of a vector aligned with the inclination of the magnetic field detected by the magnetic sensors 16.

When the angular position of the orientation sensor 10 is changed, the signal generated from at least one of the magnetic sensors 16 will also change. Based on the detected change, the processing unit 14 calculates a new vector still having a direction coincident with the inclination of the magnetic field detected. This new vector is then compared with the previous vector to determine a new sensor position. It is important to note that if the orientation sensor 10 remains in generally the same geographic position, knowledge of the inclination of the magnetic field is unnecessary, thereby making the orientation sensor easy to use.

To initialize the orientation sensor 10, the sensor is placed in a 3-axis Helmholtz calibration coil, which performs a three-axis scan. The scan will “map” the ratio of signals from the various magnetic sensors 16 thereby relating the magnetic sensors, by signal and spatially, one to the other. Where the magnetic sensors 16 provide an electrical signal, the magnetic sensors are electrically related. This “map” is unique to an orientation sensor and only need be accomplished once, as long as the spatial and signal relationship among the magnetic sensors 16 is not altered. Due to this procedure, the magnetic sensors 16 need not have the same offset and sensitivity one to the other, as differences are noted and can thus be accounted for. As a result, the manufacturing tolerances associated with the construction of the magnetic sensor array 12 are greatly reduced as well as the cost of the orientation sensor.

While the data from all magnetic sensors 16 could be used to determine a vector having a direction consistent with the inclination of the magnetic field, it is preferred that the three magnetic sensors, out of the four attached to the sensor body, with the strongest magnetic field readings be used. In this configuration, this means that the processor 14 will disregard the signal generated by the sensor that detects the weakest magnetic field.

In situations where the geographic location of the orientation sensor 10 may change during operation, a location system 34, such as a Global Positioning System (GPS), may be incorporated into the orientation sensor. By knowing changes in location, changes in the inclination of the magnetic field can be accounted for to increase the accuracy of the orientation sensor 10. Within the context of the earth's magnetic field, the inclination changes from 0 degrees at the magnetic equator to 90 degrees at a pole, north or south. Changes in inclination of the earth's magnetic field between the magnetic equator and poles are documented in such models as the World Magnetic Model. By keeping track of the position of the orientation sensor 10 on the earth's surface, the World Magnetic Model can be used to correct any detected change in angular orientation resulting from a naturally occurring change in the inclination of the earth's magnetic field.

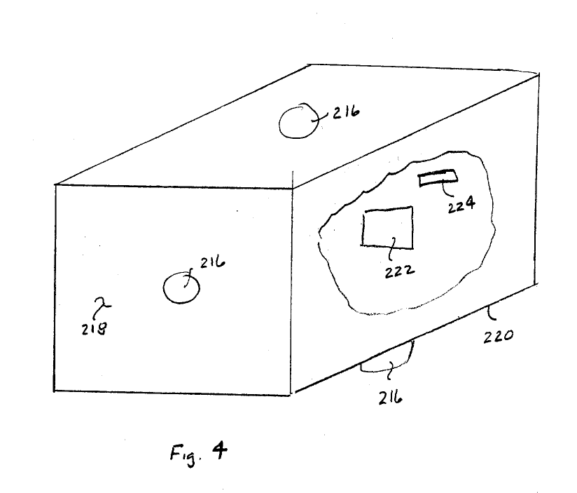

A second embodiment of the orientation sensor 210 is shown in FIGS. 3-4. As many features of this embodiment are similar to the previously discussed embodiment, the same reference numbers preceded by the number 2 will be used for similar elements. In this embodiment, six magnetic sensors 216 are mounted on a rectangular sensor body 218, one on each exposed face. In addition, a rare earth magnet 224, having a magnetic strength of 2 KG (kilogauss) is placed proximate the magnetic sensors 216 to hard bias them. Preferably, each magnetic sensor 216 has a dedicated rare earth magnet 224 associated with the sensor for hard biasing the sensor.

In operation, only three out of the four magnetic sensors 216 need function. When more than three magnetic sensors 216 are operating, the processor 214 may disregard the signals from up to three of the magnetic sensors—the three magnetic sensors indicating the weakest magnetic field readings. In the event of a failure of one of the magnetic sensors 216, the orientation sensor 210 becomes a five-magnetic sensor device. The processor 214 will immediately eliminate the failed magnetic sensor 216, since the failed magnetic sensor would be one of those indicating the weakest reading. If two magnetic sensors 216 fail, the orientation sensor 210 becomes a four magnetic sensor device and so on.

Employing neural net processing, the processor 214 may be programmed to differentiate between changes in signal output indicating changes in angular position verses changes resulting from environmental anomalies, such as proximity to ferrous bodies. This would be accomplished by pattern recognition associated with magnetic sensor signal output. With proper processing, the orientation sensor 10 would be able to determine the direction of the anomaly with respect to the orientation sensor.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. An orientation sensor comprising:
a sensor body;
at least four magnetic sensors coupled to the sensor body, the sensors being positioned in a non-planar arrangement, one relative to the other;
a processor in communication with the magnetic sensors, the processor being programmed to compute, based on signals generated by at least three of the sensors, the magnitude of a vector oriented in a direction substantially coincident with an inclination direction of a magnetic field in which the sensor is located.

2. The orientation sensor of claim 1 wherein there are at least six magnetic sensors.

3. The orientation sensor of claim 2 wherein there are six magnetic sensors, each located on a face of a rectangular sensor body.

4. The orientation sensor of claim 1 further including a magnet positioned proximate the at least four magnetic sensors for hard biasing the magnetic sensors.

5. The orientation sensor of claim 1 further including a plurality of magnets each dedicated and positioned proximate to an associated one of the at least four magnetic sensors for hard biasing the magnetic sensors.

6. The orientation sensor of claim 1 wherein the processor is programmed to disregard the weakest signal generated simultaneously by each of the sensors.

7. The orientation sensor of claim 1 further including a location system capable of identifying a position at which the orientation sensor is located.

8. A method of measuring changes in angular position of an orientation sensor:
providing an orientation sensor having a plurality of magnetic sensors associated therewith and arranged in a non-planar array relative to one another;
positioning the orientation sensor in a magnetic field;
each magnetic sensor generating signals indicative of magnetic field magnitude and orientation proximate the magnetic sensor;
receiving the signals generated by each sensor in a processor forming part of the orientation sensor;
determining the magnitude of a first vector having a direction substantially coincident with the inclination of the magnetic field;
determining the magnitude of a second vector having a direction substantially coincident with the inclination of the magnetic field, the second vector being based on signals generated subsequent to those used to determine the magnitude and orientation of the first vector; and
comparing the direction of the first vector to the direction of the second vector to determine a change in angular position of the orientation sensor.

9. The method of claim 8 wherein the orientation sensor comprises at least four magnetic sensors in a fixed, non-planar spatial relationship relative to one another.

10. The method of claim 8 wherein the orientation sensor includes a magnet positioned proximate the at least four magnetic sensors to hard bias the magnetic sensors.

11. The method of claim 8, wherein the orientation sensor includes a plurality of magnets each dedicated and positioned proximate to an associated one of the at least four magnetic sensors to hard bias the magnetic sensors.

12. The method of claim 9 wherein the orientation sensor includes four magnetic sensors and said steps of determining the magnitudes of the first and second vectors include discarding one of the signals generated by one of the four magnetic sensors.

13. The method of claim 9 wherein the magnetic sensors are of the bipolar magnetoresistive type.
